(19) United States
(12) Patent Application Publication
(10) Pub. No.: US 2020/0311223 A1
(43) Pub. Date: Oct. 1, 2020

(54) METHOD FOR DETERMINING LAYOUT OF ELEMENT AND DISPLAY DEVICE

(71) Applicants: Kabushiki Kaisha Toshiba, Tokyo (JP); Toshiba Electronic Devices & Storage Corporation, Tokyo (JP)

(72) Inventor: Toyokazu Shibata, Kawasaki Kanagawa (JP)

(21) Appl. No.: 16/540,292

(22) Filed: Aug. 14, 2019

(30) Foreign Application Priority Data
Mar. 25, 2019 (JP) 2019-055977

(51) Int. Cl. G06F 17/50

(52) U.S. Cl. CPC G06F 17/5072; G06F 2217/02

(57) ABSTRACT

According to one embodiment, a method for determining layout of an element includes selecting, among stress distribution information of a semiconductor chip, stress distribution information of a stress component in a same direction as a current that flows through an element placed in the semiconductor chip, calculating, from the selected stress distribution information, a stress value at a coordinate at which the element is placed, and calculating, from the stress value, a score according to a degree of influence of characteristics fluctuation of the element due to the stress.

### CROSS-REFERENCE TO RELATED APPLICATIONS

This application is based upon and claims the benefit of priority from the Japanese Patent Application No. 2019-055977, filed Mar. 25, 2019, the entire contents of which are incorporated herein by reference.

### FIELD

Embodiments described herein relate generally to a method for determining a layout of an element and to a display device.

### BACKGROUND

It is known that when an element mounted on a semiconductor chip receives stress from packages or the like, the resistance value or the like of the element fluctuates. When the resistance value or the like of the element fluctuates, the element may not satisfy assumed circuit characteristics. Therefore, the layout of the element is determined by stress considerations in stress simulations, stress design guides and the like.

### BRIEF DESCRIPTION OF THE DRAWING(S)

FIG. 1 is a block view showing a. configuration of a display device according to an embodiment.

FIG. 2 is a view showing an example of an X-direction, a Y-direction, and a Z-direction. set in a semiconductor chip.

FIG. 3 is a view showing an example of a current flow direction in an element.

FIG. 4 is a flowchart showing an operation by the display device.

FIG. 5 is a view showing how to decide scores.

FIG. 6A is a view showing examples of correspondence relationships between scores and display colors of elements having a low degree of tolerable characteristics fluctuation.

FIG. 6B is a view showing examples of correspondence relationships between scores and display colors of elements having a medium degree of tolerable characteristics fluctuation.

FIG. 6C is a view showing examples of correspondence relationships between scores and display colors of elements having a high degree of tolerable characteristics fluctuation.

FIG. 7 is a view showing a display example of the degree of influence of the characteristics fluctuation in a single element.

FIG. 8 is a view showing a display example of the degree of influence of the characteristics fluctuation in a pair element.

FIG. 9 is a view showing the flow of process in a first modification.

FIG. 10 is a view showing a display example of the degree of influence of the characteristics fluctuation between packages.

FIG. 11 is a view showing the flow of process in a second modification.

FIG. 12 is a view showing a display example of a recommended position.

### DETAILED DESCRIPTION

In general, according to one embodiment, a method for determining layout of an element includes selecting, among stress distribution information of a semiconductor chip, stress distribution information of a stress component in a same direction as a current that flows through an element placed in the semiconductor chip, calculating, from the selected stress distribution information, a stress value at a coordinate at which the element is placed, and calculating, from the stress value, a score according to a degree of influence of characteristics fluctuation of the element due to the stress.

Hereinafter, embodiments will be described with reference to the drawings. FIG. 1 is a block view showing a configuration of a display device according to an embodiment. A display device 1 is applied to, for example, a personal computer. The display device 1 includes a processor 11, a memory 12, an input interface 13, a display 14, and a communication interface 15. The display device 1 may be configured to communicate with the database 2.

The processor 11 is, for example, a CPU. The processor 11 controls various processes in the display device 1. The processor 11 may be an ASIC, an FPGA, a GPU the like. Further, the processor 11 may be configured of a plurality of CPUs and the like.

The memory 12 includes a RAM and a ROM. The RAM is a readable and writable semiconductor memory. The RAM is a working memory for temporarily string various data used by the processor 11 and the like. The ROM is a read-only semiconductor memory. The ROM stores data necessary for the operation by the display device 1. The ROM may store, for example, an element layout determining program for determining whether a placement of an element on a semiconductor chip is good or bad. Here, the semiconductor chip. is a chip in which various semiconductor elements are mounted on a substrate. The semiconductor chip is enclosed in a package. The semiconductor elements include single elements and pair elements. A single element is an element which functions solo, such as a resistor or a capacitor. It should be noted that a single element may include wiring or the like. That is, the single element is not particularly limited as long as it is an element whose characteristics fluctuate due to stress from, for example, the substrate or package of the semiconductor chip. A pair element is an element formed of a pair of two elements for providing a given function. Amplifier circuits, for example, are pair elements of two transistors that are paired. Semiconductor elements may contain elements consisting of a combination of single elements and pair elements.

The input interface 13 is a keyboard, a mouse or the like. The input interface 13 is an interface for users to make various inputs to the display device 1.

The display 14 is, for example, a liquid crystal display. The display 14 displays various screens.

The communication interface 15 is an interface for communication between the display device 1 and the database 2. The communication interface 15 is, for example, an interface of a wired LAN. The communication interface 15 may be a wireless LAN interface.

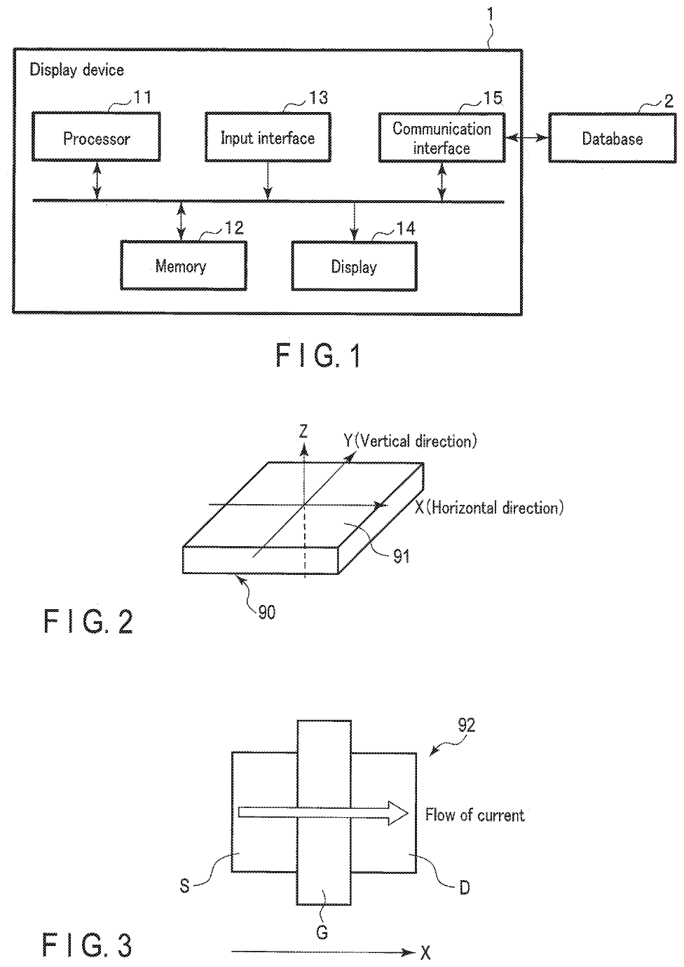

The database 2 includes a storage for storing stress distribution information for each semiconductor chip. The storage may be a hard disk or the like. The stress distribution information is information that represents, for example, a distribution of the strength of stress applied to the semiconductor chip by the substrate or the package. In the semiconductor chip, a horizontal direction (X-direction) and a vertical direction (Y-direction) are defined. The database 2 stores, as stress distribution information: stress distribution information representing the distribution of stress applied in the X-direction of the semiconductor chip, and stress distribution information representing the distribution of stress applied in the Y-direction of the semiconductor chip. When the elements in the semiconductor chip have a three-dimensional structure, the database 2 may store, as stress distribution information, stress distribution information in a Z--direction representing the distribution of stress applied in the Z-direction of the semiconductor chip. FIG. 2 is a view showing an example of the X-direction, the Y-direction, and the Z-direction set in the semiconductor chip. As shown in FIG. 2, the X-direction is a direction that is parallel to an element layout surface 91 that is the surface on which the elements in the semiconductor chip 90 are placed, i.e. the X-direction is the horizontal direction. The Y-direction is a direction that is parallel to the element placement surface 91 and orthogonal to the X-direction, i.e. the Y-direction is the vertical direction. The direction is the direction normal to the element placement surface 91.

The database 2 may store element information that includes: information indicating coordinates of the elements placed on the semiconductor chip 90, and direction of the currents flowing through the elements. FIG. 3 is a view showing an example of the direction, the current flowing through the element. For example, the element mounted on the semiconductor chip 90 is assumed to be the MOS transistor 92. In the case of the MOS transistor 92, when a voltage is applied to a gate electrode G, a current flows from a source electrode S to a drain electrode D. Therefore, for example, as shown in FIG. 3, if the MOS transistor 92 is placed on the semiconductor chip 90 so that the source electrode S, the gate electrode G, and the drain electrode D are aligned in the X-direction, the direction of the current flowing through the element is the X-direction. On the other hand, although not shown, if the MOS transistor 92 is placed on the semiconductor chip 90 so that the source electrode S, the gate electrode G, and the drain electrode D are aligned in the Y-direction, the direction of the current flowing through the element is the Y-direction. The element information includes information on the degree of tolerable characteristics fluctuation due to stress. The element information may be, for example, design data of the semiconductor chip.

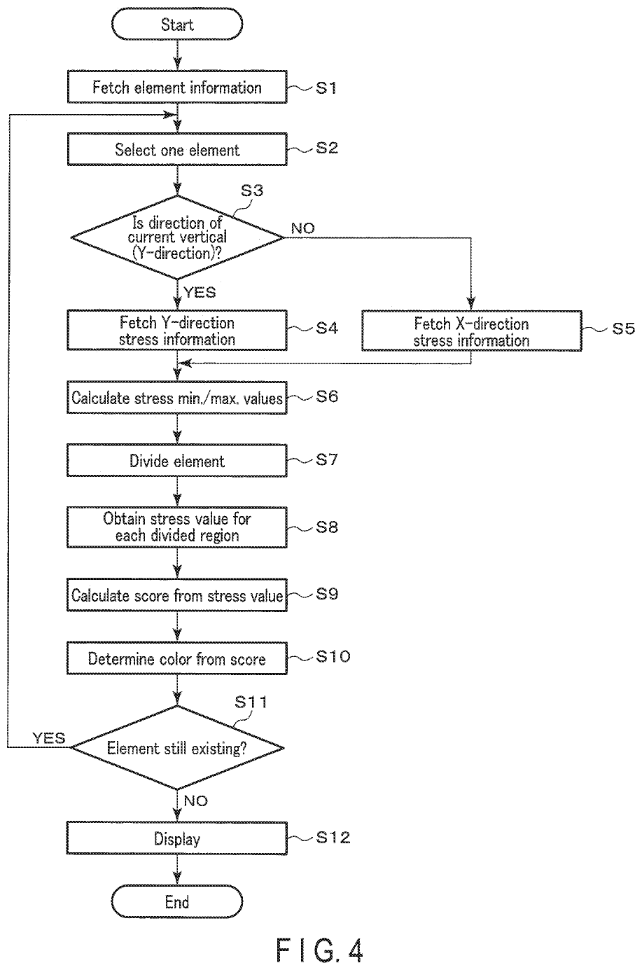

Next, the operation by the display device 1 will be described FIG. 4 is a flowchart showing the operation by the display device 1. The process of FIG. 4 is started, for example, when the element layout determining program is executed by the processor 11. In step S1, the processor 11 fetches, from the database 2, the element information of the elements mounted. on the semiconductor chip that is the target of the element layout determination. The element information may be input by the user.

In step S2, the processor 11 selects the element information of an element among the fetched element information.

In step S3, the processor 11 determines whether or not the direction of the current flowing through the selected element is the vertical direction. For example, the characteristics of elements such as resistors fluctuate as the stress applied in the same direction as the current flowing through the elements becomes dominant. Therefore, the influence of the stress applied to the element can be appropriately evaluated in the subsequent scoring process by determining the influence of the stress applied to the elements from the stress in the same direction as the current flowing through the elements. Step S3 is a process for determining stress distribution information from the stress component in the same direction as the current flowing through the elements. If it is determined in step S3 that the direction of the current flowing through the elements is the vertical direction, the process proceeds to step S4. If it is determined in step S3 that the direction of the current flowing through the elements is not the vertical direction but the horizontal direction, the process proceeds to step S5.

In step S4, the processor 11 fetches, from the database 2, stress distribution information in the same direction as the current flowing through the selected element, i.e. the vertical direction of the semiconductor chip whose element layout is to be determined. In step S5, the processor 11 fetches, from the database 2, stress distribution information in the same direction as the current flowing through the selected element, i.e. the horizontal direction of the semiconductor chip whose element layout is to be determined. After step S4 or step S5, the process proceeds to step S6.

In step S6, the processor 11 calculates the minimum stress value F_{Min} and the maximum stress value Fₘₐₓ among the obtained stress distribution information. It is preferable that the processor 11 calculate the maximum stress value after excluding the stress value at the edge position of the semiconductor chip where the stress value is extremely large. This is because the element is usually not placed at the edge position, and because an event should be avoided where an unnecessarily low point is calculated during the stress scoring (see below) due to the use of such an extremely large stress value.

In step S7, the processor 11 divides the elements into a plurality of regions. These regions each are, for example, a lattice region of about the size of one single element, that is, for example, about 5 μm to 10 μm on one side. As described above, the single element is an element that functions solo such as a resistor. On the other hand, a pair element is an element in which two single elements function as a pair. For example, an amplifier circuit is configured by two transistors arranged together as a pair. Here, one transistor or the like that constitutes a pair element may itself be formed from several single transistor elements. A pair element has a certain size as being a group of single elements. An element having a certain size, e.g., as large as extending over a plurality of coordinates, may receive different stresses depending on the location. For this reason, such an element is divided into a plurality of regions to obtain the stress value at each portion location of the element.

In step S8, the processor 11 obtains a stress value for each of the divided regions from the stress distribution information.

In step S9, the processor 11 calculates the score for each of the divided regions from the obtained stress value. The score is calculated based on different criteria depending on whether the element being selected is a single element or a pair element.

In the case of a single element, the smaller the stress value applied to the element, the less the influence of the characteristics fluctuation, in which case n be said that the single element is placed in good coordinates. Therefore, the score of the single element is expressed as, for example, the percentage of the element's stress value with 0 points as the minimum stress distribution value and 100 points as the maximum stress distribution value. For example, the score S1 of a single element is calculated by the following (Formula 1):

S1=(F−F_{Min})/(F_{Max}−F_{Min})×100 (Formula 1)

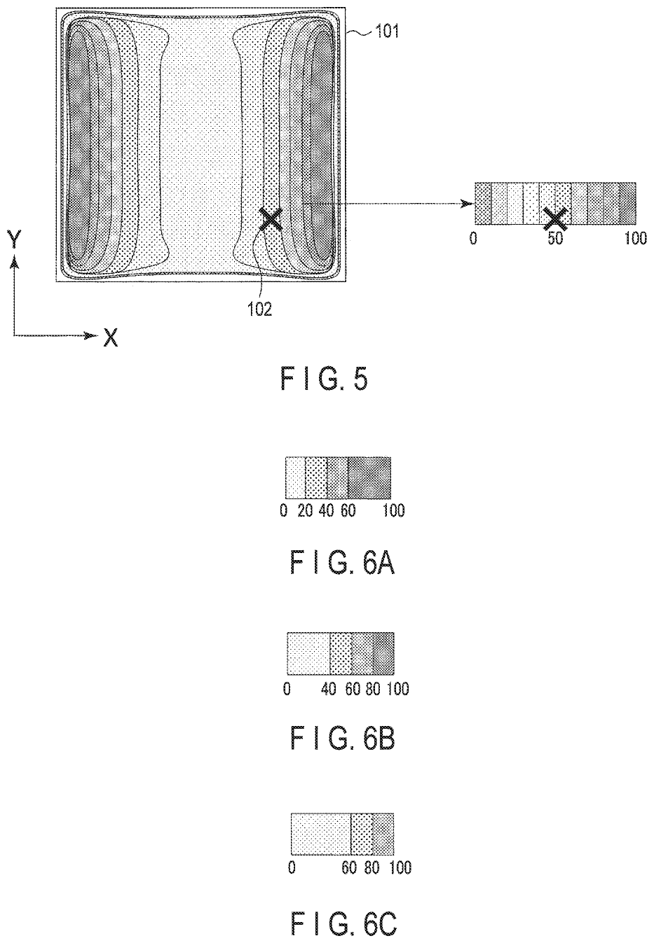

Here, F is the element's stress value, Fₘᵢₙ is the minimum stress value, and F_{Max} is the maximum stress value. For example, when the stress distribution information of, for example, the substrate of the semiconductor chip is the X-direction stress distribution information 101 shown in FIG. 5,the score of the element located at the coordinate 102 is 50 points.

On the other hand, in the case of a pair element, the magnitude of the stress value applied to each element is not a great importance. Rather, the smaller the difference in stress value between pair-constituting elements (i.e. the smaller the variation in the characteristics fluctuation between the elements forming a pair), the less the influence of the characteristics fluctuation of the pair element in its entirety, in which case it can be said that the pair element is placed in good coordinates. Therefore, the score of the pair element is expressed, for example, as percentage of the stress difference between pair-constituting elements with 0 points as stress difference 0 and 100 points as a predetermined stress difference limit value Lim. For example, the score S2 of a pair element is calculated by the following (Formula 2):

S2=|F1−F2|/Lim×100 (Formula 2)

Here, F1 is the stress value of one of the elements of a pair (element 1), F2 is the stress value of the other one of the pair (element 2), and Lim is the limit value of the stress difference. F1 is represented by the following (Formula 3), and F2 is represented by the following (Formula 4).

F1=((F11²+F12²+ . . . +F1n²)/n)^{1/2} (Formula 3)

F2=((F21²+F22²+ . . . +F2n²)/n)^{1/2} (Formula 4)

Here, F1n (n=1, 2, 3, . . . ) is the stress value in the coordinate 1n of the element 1, F2n (n=1, 2, 3, . . . ) is the stress value in. the coordinate 2n of the element 2, and n is the number of regions of the elements 1 and 2.

Here, referring back to the explanation of FIG. 4, in step S10, the processor 11 determines a. display color according to the score. In the embodiment, the influence degree of the fluctuation of the characteristic of the element due to the stress is color-coded and displayed based on the score. For example, the processor 11 determines the display color to display coordinates in which the degree of influence of the characteristic change is low in blue and to display coordinates in which the degree of influence of the characteristic change is high in red. Here, it is assumed that the method of color coding can adopt, for example, three different stages according to the degree of tolerable characteristics fluctuation of each element. For example, for elements in which the characteristics fluctuation has to be suppressed as much as possible, the score range in which the display color approximates red is broadened, and, for elements in which the characteristics fluctuation can be tolerated to a certain extent, the score range in which the display color approximates blue is broadened.

FIG. 6A is a view showing an example of the correspondence relationships between the scores and the display colors of the elements having a low degree of tolerable characteristics fluctuation. In the example of FIG. 6A, the display color from 0 points to 20 points is set to blue, the display color from 21 points to 40 points is set to green, the display color from 41 points to 60 points is set to yellow, and the display color from 61 points to 100 points is set to red.

FIG. 6B is a view showing an example of the correspondence relationships between the scores and the display colors of the. elements having a medium characteristic fluctuation tolerance. In the example of FIG. 6B, the display color from 0 points to 40 points is set to blue, the display color from 41 points to 60 points is set to green, the display color from 61 points to 80 points is set to yellow, and the display color from 81 points to 100 points is set to red.

FIG. 6C is a view showing an example of the correspondence relationships between the scores and the display colors of the element having a. high degree of tolerable characteristics fluctuation. In the example of FIG. 6C, the display color from 0 points to 60 points is set to blue, the display color from 61 points to 80 points is set to green, and the display color from 81 points to 100 points is set to yellow.

The processor 11 selects, according to the degree of tolerable characteristics fluctuation of the currently selected element, one of: the correspondence relationship shown in FIG. 6A, the correspondence relationship shown in FIG. 6B, and the correspondence relationship shown in FIG. 6C. Then, according to the selected correspondence relationship and the calculated score, the display color is determined. Thereafter, the process proceeds to step S11.

Here, the correspondence relationships between the scores and the display colors use, for example, three stages. However, there is no limit to the number of stages. In other words, the correspondence relationships between scores and display colors may not even use different stages, or may use two stages, or four or even more stages.

In step S11, the processor 11 determines whether or not there is an element not selected yet. If it is determined in step S11 that there is still an unselected element, the process returns to step S2. In this case, the processor 11 selects another element. If it is determined in step S11 that there is no unselected element, the process proceeds to step S12.

In step S12, the processor 11 color-codes the degree of influence of the characteristics fluctuation due to the stress of each element, and causes this to he displayed on the display 14. After that, the processor 11 ends the process shown in FIG. 4.

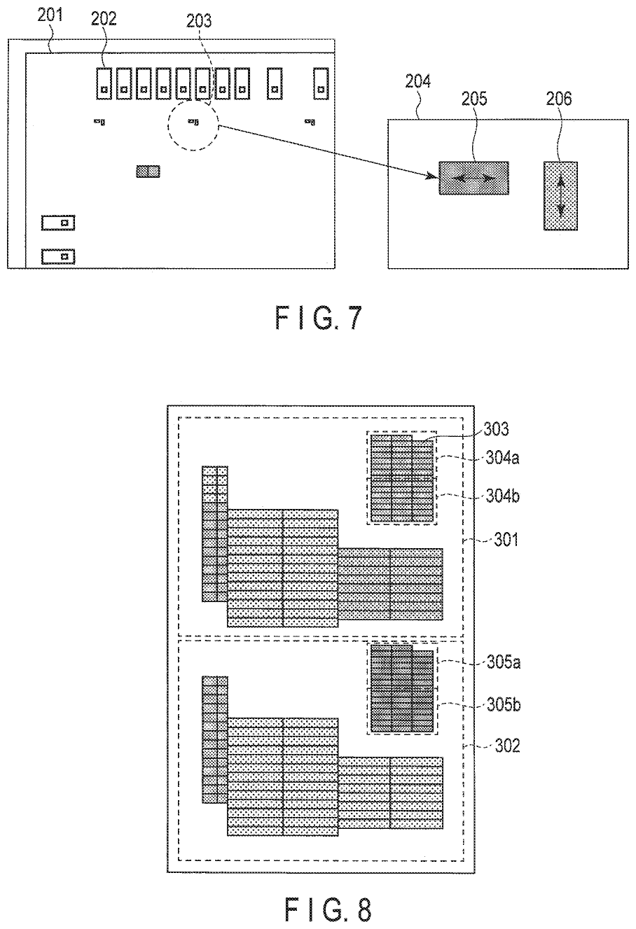

FIG. 7 is a view showing a display example of the degree of influence of the characteristics fluctuation in a single element. For example, a frame 201 is displayed on the display 14. The frame 201 represents the outer shape of the semiconductor chip. In the vicinity of the frame 201, a pad image 202 may be displayed. The pad image 202 is an image representing the position of the pad on the semiconductor chip. The frame 201 and the pad image 202 allow the user to easily understand the positional relationships between the elements placed on the semiconductor chip.

The influence degree 203 of the characteristics fluctuation in a single element is displayed at the coordinate of the corresponding element in the frame 201. FIG. 7 further depicts an enlarged view 204 of the display of the influence degree 203. As shown in the enlarged view 204, the display of the influence degree 203 includes, for example, two arrow images 205 and 206. The arrow image 205 indicates the degree of influence when the element is placed such that a current flows in the horizontal direction of the semiconductor chip. The arrow image 206 shows the degree of influence when the element is placed such that the current flows in the vertical direction of the semiconductor chip. As shown in the enlarged view 204, the arrow images 205 and 206 are displayed, respectively, in the colors determined in step 610. The color of the arrow image 205 is, for example, red. This indicates that the degree of influence of the characteristics fluctuation when the element is placed in the horizontal direction is intolerably large. The color of the arrow image 206 is, for example, blue. This indicates that the degree of influence of the characteristics fluctuation when the element is placed in the vertical direction is tolerably low. The user who sees such a display can consider whether the element can be placed in the vertical direction. Here, in FIG. 7, the display of the influence degree 203 includes the two arrow images 205 and 206. However, it may include only one of the arrow images.

FIG. 8 is a view showing a display example of the degree of influence of the characteristics fluctuation in a pair element. Here, although omitted in FIG. 8, the frame 201 and the pad image 202 may be displayed also in the case of a pair element.

For a pair element, the degree of influence of the characteristics fluctuation is displayed for each region of a pair element. Here, FIG. 8 is a view showing a display example of the degree of influence of the characteristics fluctuation in amplifier circuits. FIG. 8 shows a display example of the amplifier circuits 301, 302 having identical configuration, placed at different coordinates.

In FIG. 8, a single rectangular region 303 represents a single transistor element. As shown in FIG. 8, in the amplifier circuit 301, the single transistor elements then together form transistors 304a and 304b as pair-constituting elements. The display color of each rectangular region 303 in the transistors 304a, 304b is determined from the score determined by the difference between the stress value of the transistor 304a and the stress value of the transistor 304b. For example, the display color of the pair-constituting transistors 304a, 304b in FIG. 8 is yellow. In other words, it is shown that the degree of influence of the characteristics fluctuation in the location where the transistors 304a, 304b are placed is relatively high.

The display color of the pair-constituting transistors 305a, 305b in the amplifier circuit 302 is red. The transistors 304a, 305a have the same configuration, and, similarly, the transistors 304b, 305b have the same configuration. In other words, FIG. 8 shows that there is a difference in the degree of influence of the characteristics fluctuation due to the difference in the coordinates at which the amplifier circuit 301 and the amplifier circuit 302 are placed.

As described above, in the present embodiment, stress distribution information of stress components in the same direction as the direction of the current flowing through the elements is obtained to calculate the stress value of the elements. In other words, in the embodiment, the stress value of the elements is calculated. based on stress distribution information dominantly affecting the characteristics of the elements. In this manner, it is possible to appropriately determine whether the elements are placed. well or had.

In the embodiment, the degree of influence of the characteristics fluctuation of each element is scored according to the stress value of the elements. This makes it easy to evaluate the degree of influence of the characteristics fluctuation of each element. When evaluating, various statistical processes may be performed such as extracting a peak value of the degree of influence of the fluctuation, and expressing the scores as a histogram of the degree of influence of the fluctuation, in addition to the color coding described above.

Further, in the embodiment, the degree of influence of the characteristics fluctuation of each element is displayed in different colors. Thereby, the user can easily judge the quality of the layout of the elements. Also, in the embodiment, different color coding is performed according to the degree of tolerable characteristics fluctuation. Thereby, the layout of the elements according to the characteristics of each element can be judged. For example, the user can consider moving an element having a large degree of tolerable fluctuation to another coordinate in favor of an element having a small degree of tolerable fluctuation.

### Modification 1

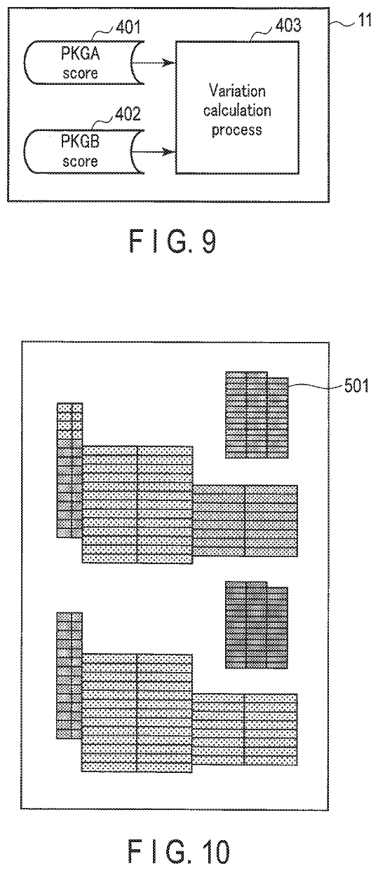

Hereinafter, modifications will be described. FIG. 9 is a view showing the flow of processing according to a first modification. The semiconductor chip can be enclosed in a plurality of packages. The techniques of the embodiments can also be used for performance evaluation among these multiple packages. Hereinafter, performance evaluation of a package A and a package B in which the same elements are mounted will be described as an example.

The processor 11 calculates the score 401 of each element of the package A (PKG A) from the element information of the package A and the stress distribution information. Similarly, the processor 11 calculates the score 402 of each element of the package B (PKG B) from the element information of the package B and the stress distribution information. The calculation process of these scores is the same as the process described in relation to FIG. 4. After calculating the scores 401 of the respective elements of the package A and the scores 402 of the respective elements of the package B, the processor 11 performs a fluctuation calculation process 403 for fluctuation (variation) between packages. This inter-package fluctuation calculation process 403 is a process of comparing the score 401 of each element of the package A and the score 402 of each element of the package B for each region to select a large value. After that, the processor 11 causes the display 14 to display the degree of influence of the characteristics fluctuation between the packages.

FIG. 10 is a view showing a display example of the degree of influence of the characteristics fluctuation between the packages. Here, FIG. 10 shows a display example of the influence degree of the characteristics fluctuation between the package A and the package B in which the amplifier circuits 301, 302 shown in FIG. 8 are packaged. The display color of each rectangular region 501 is determined from the score determined by the difference between the score of the element of the package A and the score of the element of the package B. Thus, the more red the display color, the greater the fluctuation or variation in performance among the packages.

As described above, in the first modification, the technology of the embodiment can be applied to performance evaluation between packages.

In the example of FIG. 9, it is assumed that the fluctuation calculation process 403 is performed between two packages. However, this process is not limited thereto. In other words, the fluctuation calculation process 403 may be performed between three or more packages. In this case, the processor 11 compares the scores of the elements between the packages for each region and selects the one with the largest value.

### Modification 2

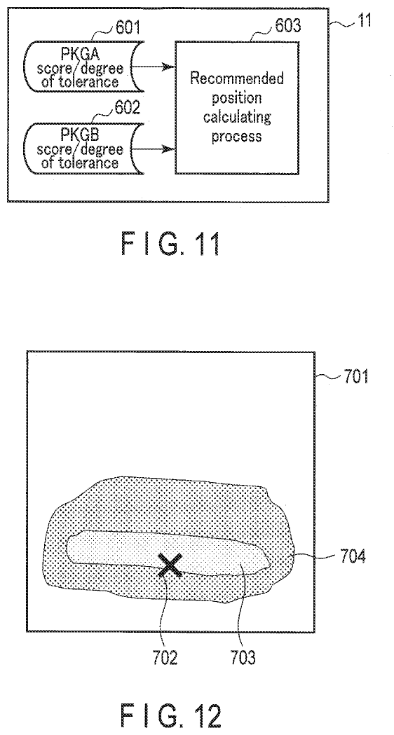

FIG. 11 is a view showing the process flow of the second modification. In the above-described embodiments, the score indicating the degree of influence of the characteristics fluctuation in the coordinates is calculated when the coordinates at which the elements are placed have already been determined. But even if the coordinates at which the elements are placed have not been determined, the recommended position of the elements can be calculated by the technique described in the embodiments. Hereinafter, as an example, the calculation of the recommended positions of the elements in the two packages A and B where the same elements are to be mounted will be described.

The processor 11 calculates, from the stress distribution information, a score based on an assumption that an element to be mounted on the package A is placed at each coordinate of the semiconductor chip. That is, the processor 11 calculates, from the stress distribution information of the package A, the score for each coordinate on the assumption that the element is placed so that the current flows in the horizontal direction of the semiconductor chip of the package A, and the score for each coordinate on the assumption that the element is placed so that the current flows in the vertical direction of the semiconductor chip. Similarly, the processor 11 calculates, from the stress distribution information of the package B, the score for each coordinate on the assumption that the element is placed so that the current flows in the horizontal direction of the semiconductor chip of the package B, and the score for each coordinate on the assumption that the element is placed so that the current flows in the vertical direction of the semiconductor chip. These score calculation processes are the same as in FIG. 4. Also, the processor 11 obtains the degree of tolerable characteristics fluctuation of the element in the package

A and the degree of tolerable characteristics fluctuation of the element in the package B.

After calculating the score for each coordinate of the element of the package A and the score for each coordinate of the element of package B and obtaining the degree of tolerable characteristics fluctuation of the element in the package A and the degree of tolerable characteristics fluctuation of the element in the package B, the processor 11 performs a recommended position calculating process 603. In the recommended position calculation process, the color determined by the score for each coordinate of the element of the package A and by the degree of its tolerable fluctuation 601 is compared to the color determined by the score for each coordinate of the element of the package B and by the degree of its tolerable fluctuation 602, and the color is selected that is closer to blue, i.e. that is indicative of a lower score including the degree of tolerance. After that, the processor 11 causes the display 14 to display the recommended placement coordinates.

FIG. 12 is a view showing a. display example of recommended placement coordinates. In the example of FIG. 12, a cross mark 702 is shown that indicates the recommended layout coordinate for the coordinate having the lowest score including the degree of tolerance in a frame 701 representing the semiconductor chip. The region of blue display color is a recommended range 703. The region of green display color is a second-recommended range 704.

As described above, in the second modification, the recommended placement coordinates of an element are displayed according to the score per coordinate of this one element and the degree of its tolerable characteristics fluctuation. In this manner, the user can determine the element layout by prior consideration. As a result, it takes less time to correct the element layout.

In the example of FIG. 11, the recommended position calculating process 603 is performed with the information of two packages. However, the process is not limited thereto. In other words, the recommended position calculating process 603 may be performed with only one package. In this case, the processor 11 calculates the recommended position according to the fashion of the color coding explained in relation to FIG. 4. Further, the recommended position calculating process 603 may be performed with the information of three or more packages.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for determining layout of an element, comprising:
selecting, among stress distribution information of a semiconductor chip, stress distribution information of a stress component in a same direction as a current that flows through an element placed in the semiconductor chip;
calculating, from the selected stress distribution information, a stress value at a coordinate at which the element is placed; and
calculating, from the stress value, a score according to a degree of influence of characteristics fluctuation of the element due to the stress.

2. A display device, comprising:
a display configured to display a screen; and
a processor configured to:
select, among stress distribution information of a semiconductor chip, stress distribution information of a stress component in a same direction as a current that flows through an element placed in the semiconductor chip;
calculate, from the selected stress distribution information, a stress value at a coordinate at which the element is placed;
calculate, from the stress value, a first score according to a degree of influence of characteristics fluctuation of the element due to the stress; and
cause, based on the first score, the degree of influence of characteristics fluctuation to be displayed on the display.

3. The display device according to claim 2, wherein the processor is configured to color-code the degree of influence of characteristics fluctuation and cause the same to be displayed on the display.

4. The display device according to claim 3, wherein the processor is configured to vary a fashion of color-coding the degree of influence of characteristics fluctuation according to a degree of tolerable characteristics fluctuation of the element.

5. The display device according to claim 2, wherein:
the element is placed across a plurality of coordinates, and
the processor is configured to:
divide, according to a size of the element, the element into a plurality of regions, p2 calculate the stress value for each of the regions;
calculate the first score for each of the regions; and
cause the degree of influence of characteristics fluctuation for each of the regions to be displayed.

6. The display device according to claim 2, wherein:
the element includes a first element and a second element having same configuration and sealed in respective, different packages; and
the processor is configured to cause the greater of: the degree of influence of characteristics fluctuation for the first element and the degree of influence of characteristics fluctuation for the second element to be displayed on the display.

7. The display device according to claim 6, wherein the processor is further configured to:
calculate a second score that is in accordance with a difference between the degree of influence of characteristics fluctuation for the first element and the degree of influence of characteristics fluctuation for the second element; and
color-code, based on the second score, the difference for each coordinate of the element and cause the same to be displayed on the display.

8. The display device according to claim 2, wherein the processor is further configured to:
calculate, based on the first score, a recommended placement coordinate at which a placement of the element is recommended; and
cause the recommended placement coordinate to be displayed on the display.

9. The display device according to claim 2, wherein the processor is configured to extract, from design data of the semiconductor chip: a coordinate of the element and a direction in which a current flows through the element.
